(19) United States
(12) Patent Application Publication
(10) Pub. No.: US 2010/0317640 A1
(43) Pub. Date: Dec. 16, 2010

(54) ANTIMICROBIAL ZINC PYRITHIONE COMPOSITION AND METHOD

(75) Inventors: BURKE I. NELSON, Mooresville, NC (US); Veronica R. Steinmetz, Sherrills Ford, NC (US); Ivan Wei-kang Ong, Charlotte, NC (US)

Correspondence Address: MICROBAN PRODUCTS COMPANY, 11400 VANSTORY DRIVE, HUNTERSVILLE, NC, 28078, US

(73) Assignee: MICROBAN PRODUCTS COMPANY, HUNTERSVILLE, NC (US)

(21) Appl. No.: 12/772,265

(22) Filed: May 3, 2010

Related U.S. Application Data
(60) Provisional application No. 61/174,795, filed on May 1, 2009.

(51) Int. Cl. A01N 55/02; A01P 3/00; A01P 1/00; A01P 15/00

(52) U.S. Cl. 514/188

(57) ABSTRACT

The present invention relates to the field of antimicrobial formulations, and more specifically, to an antimicrobial formulation comprising zinc pyrithione in a stabilized dispersion.

### FIELD OF THE INVENTION

The present invention relates to the field of antimicrobial formulations, and more specifically, to an antimicrobial formulation comprising zinc pyrithione.

### BACKGROUND OF THE INVENTION

Polyvalent metal salts of pyrithione (commonly known as 1-hydroxy-2-pyridinethione; 2-pyridinethiol-1-oxide; 2-pyridinethione; 2-mercaptopyridine-N-oxide; pyridinethione; and pyridinethione-N-oxide) are known to be effective antimicrobial agents and are widely used as fungicides and bactericides in products such as antifouling paints and sealants, building products, plastics and goods made therefrom, polyurethane products, textiles, cosmetics, and in anti-dandruff shampoos.

The polyvalent metal salts of pyrithione are only sparingly soluble in water and include magnesium pyrithione, strontium pyrithione, barium pyrithione, copper pyrithione, zinc pyrithione, zirconium pyrithione, cadmium pyrithione, and bismuth pyrithione. The most widely used divalent pyrithione salts are zinc pyrithione and copper pyrithione.

Zinc pyrithione effective is insoluble in water (8 ppm at neutral pH) and sparingly soluble in most organic solvents. Useful organic solvents include alcohols (e.g. methanol, ethanol), amines (e.g. diethanolamine), ether, esters, and the like.

Even in such systems, however, zinc pyrithione is poorly maintained as a dispersion and readily precipitates. In most industrial applications, therefore, the composition must be agitated, harsh solvents must be used, and/or additional compounds employed to prevent settling. Agitation complicates the manufacturing process and, in some instances, is incompatible or impracticable. Some solvents and surfactant compounds pose complications as human health and environmental hazards, and they also may interfere with the materials into which the final product is composed.

### DETAILED DESCRIPTION

As used herein, the terms “microbe” or “microbial” should be interpreted to refer to any of the microscopic organisms studied by microbiologists or found in the use environment of a treated article. Such organisms include, but are not limited to, bacteria and fungi as well as other single-celled organisms such as mold, mildew and algae. Viral particles and other infectious agents are also included in the term microbe.

“Antimicrobial” further should be understood to encompass both microbicidal and microbistatic properties. That is, the term comprehends microbe killing, leading to a reduction in number of microbes, as well as a retarding effect of microbial growth, wherein numbers may remain more or less constant (but nonetheless allowing for slight increase/decrease).

For ease of discussion, this description uses the term antimicrobial to denote a broad spectrum activity (e.g. against bacteria and fungi). When speaking of efficacy against a particular microorganism or taxonomic rank, the more focused term will be used (e.g. antifungal to denote efficacy against fungal growth in particular).

Using the above example, it should be understood that efficacy against fungi does not in any way preclude the possibility that the same antimicrobial composition may demonstrate efficacy against another class of microbes.

For example, discussion of the strong bacterial efficacy demonstrated by a disclosed embodiment should not be read to exclude that embodiment from also demonstrating antifungal activity. This method of presentation should not be interpreted as limiting the scope of the invention in any way.

In an exemplary embodiment, an antimicrobial composition is manufactured, comprising zinc pyrithione, dipropylene glycol, and a polyethylene glycol distearate (e.g. Rewopol PEG 6000DS (Goldschmidt Rewo GmbH, Steinau an der Strasse, Germany)).

As one method to produce a 1000 gram batch, by way of example, 740 g dipropylene glycol is added to a mixing vessel and gently warmed with agitation to 60° C. To this DPG is added 10 g polyethylene glycol distearate, optionally with gentle agitation, to dissolve it and form a pre-mixture.

250 grams of zinc pyrithione then is added, with brisk agitation to ensure a good dispersion. The heat source is removed and agitation discontinued as the batch is allowed to cool to standard temperature (i.e., 25° C.). The antimicrobial composition thus formed has advantageous properties over conventional dispersed zinc pyrithione formulations.

### Example 1

### Physical Properties

During cooling in the above method, the antimicrobial composition gelates, acquiring a viscous, gelatinous consistency. Zinc pyrithione advantageously was observed to remain dispersed in the composition, rather than settling out as is commonly seen in conventional zinc pyrithione dispersions.

Viscosity of the above exemplary composition at room temperature (25° C.) was in the range of 2480-2820 centipoise (viscosity rose over 5 min time period).

The formulation recipe can be altered without deleterious effect on the properties of the antimicrobial composition. For example, the relative amount of pyrithione in the composition can be reduced to 125 grams and that of polyethylene glycol distearate compensatorily adjusted upward to a value in the range of >10 grams to <20 grams.

Similarly, the viscosity of the present composition can be altered by controlling the relative amounts of polyethylene glycol distearate and/or polyvalent metal salt of a pyrithione therein.

When 500 grams of zinc pyrithione and no polyethylene glycol distearate was added to 500 grams of dipropylene glycol in accordance with the above-discussed method, the resulting composition possessed a high thickness and did not flow.

Conversely, a composition manufactured with 125 grams of zinc pyrithione and no polyethylene glycol distearate had a viscosity of approximately 205 cP. When the same amount of zinc pyrithione was added but 5 grams of polyethylene glycol distearate also was employed, an elevated viscosity of about 685 cP was observed in the finished composition.

Having set forth the basic parameters of the present antimicrobial composition, one of ordinary skill in the art should be able to vary the amounts of the polyvalent metal salt of a pyrithione, polyethylene glycol distearate, or both as desired to achieve a selected composition viscosity.

Surprisingly, the composition was observed to remain in a gelatinous state, even if the container housing the composition was casually handled (such as during transport or movement within a facility).

Upon simple industrial agitation, however, the composition lost its gel-like viscosity and became easily flowable, facilitating its use in conventional manufacturing processes. The zinc pyrithione again was seen to remain dispersed after de-gelating agitation.

Unexpectedly, it was observed that the agitated (de-gelated) composition did not re-gelate when agitation was ceased. Rather, the composition remained in the flowable liquid state that was attained after post-manufacture agitation.

Equally unexpectedly, no settling of the zinc pyrithione was observed in the flowable composition after manufacture and de-gelation. This property is advantageous in manufacturing, removing the need for constant or intermittent agitation as is necessary with traditional dispersion formulations.

The composition as hereinabove described was used in the production of polyurethane foam samples to assess incorporation, integrity of the polymer, and antimicrobial efficacy. Polyurethane foam is a commonly used material in shoe insoles, an application wherein bacterial and fungal contamination are problematic.

To assess successful incorporation of antimicrobial agent into the polyurethane foam, a series of shoe insole samples were manufactured and assayed.

Upon manual and visual inspection, the sample outsoles had an outward appearance no different from untreated shoe insoles. Likewise, there was no overt difference in the feel, pliancy or odor of the experimental insoles as compared to untreated controls.

TABLE 1

| Sample | Analytical (ppm) |
|---|---|
| #1 - Green | 88 |
| #2 - Black | 61 |
| #3 - Green | 590 |
| #4 - Black | 67 |
| #5 - Green | 450 |
| #6 - Green (thin) | 510 |
| #7 - Green | 830 |

TABLE 1a

| Sample Description | Zn Response Intensity cps/μA |
|---|---|
| Untreated Controls | 0 (None Detected) |
| 0.4% Composition | 0.13 |
| 0.8% Composition | 0.27 |

Chemical analysis was undertaken to determine if the employment of the present antimicrobial composition resulted in successful incorporation of antimicrobially active agent in the finished polyurethane substrate. Foam samples were digested and zinc extracted therefrom.

### Example 2

### Antimicrobial Efficacy

The zinc pyrithione formulation disclosed herein possesses tremendous versatility in both polyurethane (PU) (foam and non-foamed varieties) and polyvinyl chloride (PVC) applications. For the PU applications, it affords a rapid way to introduce zinc pyrithione, itself a chemical very difficult to formulate and disperse, into cross linked liquid systems. It does not appear to affect the PU cross-linking process, which is well known to be very sensitive to water.

In order to evaluate Microban Experimental Product Z01-S4205-250 for use as an antimicrobial in polymer systems, a polyurethane foam (such as commonly used in shoe liners) was chosen for testing. Manufactured for evaluation were a number of samples, in which polyurethane foam was treated with the disclosed zinc pyrithione formulation and incorporated into a foam such as used in shoe insoles. Multiple samples of the additive were employed, made from different batches to further ensure reproducibility in making the disclosed formulation.

The PU foam samples were tested using the below-described industry standard procedures (detailed description of methods available upon request).

The AATCC Test Method 90 qualitatively determines the presence of antimicrobial activity in antimicrobial products capable of producing a zone of inhibition but lacking sufficiently flat surfaces to meet the sample requirements for typical zone of inhibition testing. Test materials of this type are partially embedded in inoculated agar to provide full surface contact with the media.

Staphylococcus aureus ATCC 6538 and Klebsiella pneumoniae ATCC 4352 typically are selected as surrogates for Gram-positive and Gram-negative bacteria, respectively.

Ideally, a sample should provide a surface area of approximately 400 to 600 mm square for contact with the inoculated media. One milliliter of each challenge organism in Trypicase Soy Broth is pipetted into separate 150 ml portions of sterile, molten Mueller-Hinton Agar maintained in a water bath at a temperature no warmer than 45° C.

For each organism, a separate 100 mm×15 mm Petri dish is filled with inoculated agar so as to create a 3 millimeter layer (i.e., about 10 ml). The agar is allowed to cool to a semi-gelatinous state, then the sample is gently pressed into the agar.

An additional amount of inoculated agar containing the same organism is poured into the plate to achieve a total depth of approximately 6 mm and only partially embed the sample.

The plate is then covered, the agar hardened, and then incubated at 37° C. for 18-24 hours.

Foam polyurethane insole samples from two batches were tested according to this protocol. Results are shown in Table 2.

TABLE 2

| Sample | TM90 Kp | TM90 Sa |
|---|---|---|
| #1 - Green | No zone | No zone |
| #2 - Black | No zone | No zone |
| #3 - Green | Zone | Zone |
| #4 - Black | No zone | No zone |
| #5 - Green | Zone | Zone |
| #6 - Green (thin) | Zone | Zone |
| #7 - Green | Zone | Zone |

Further testing was in accordance with a modified JIS Z2801:2000 test protocol (available from Japanese Industrial Standards Committee, Tokyo, Japan). The Z2801 protocol is an internationally known standard test to assess quantitative antimicrobial activity and efficacy. The protocol and specific modifications made thereto are briefly summarized below.

The comparison test for antimicrobial efficacy used Klebsiella pneumoniae, ATCC 4352. The test organism was grown, and a portion of an exponentially growing culture was collected into Japanese Nutrient Broth or Brain-Heart Infusion Broth. An inoculum was prepared at about 10⁷ colony-forming units (CFU) per milliliter by dilution with relevant broth.

Sample pieces were targeted to weigh approximately 1.0±0.2 grams. Sample test pieces were reduced to approximately 38 mm×38 mm dimensions (or as close to these dimensions as practical).

A sample was placed on moistened laboratory tissue in a culture plate, and 1.0 ml of test inoculum (10⁷ CFU) was pipetted onto the sample surface. A cover slip or film was placed over and in contact with the inoculum to ensure uniform and substantially complete coverage of the inoculum over the sample surface. The culture plate then was incubated for 24 hours at 37° with humidity.

In parallel and for each inoculum used, 1.0 ml of the inoculum was added to 99±0.1 ml of neutralizer broth, then mixed and plated in 1.0 ml of a 1/10 saline dilution in duplicate. This is done to precisely establish the concentration of the each test organism in its inoculum.

The applied liquids on the plates were allowed to dry, then the plates were inverted and incubated for 18 to 24 hours. Following incubation, the CFU on each plate were enumerated and, taking into account the dilution made, the average number of CFU applied in 1.0 ml of the inoculum calculated and recorded.

Bacteria on the sample and cover slip/film were recovered, collected into D/E Neutralizing Broth, and counted. The antimicrobial activity of the test samples is expressed herein as a log reduction value in comparison with the bacterial growth of the corresponding untreated (control) sample.

Samples—negative control and experimental additive samples 1-2—were run in duplicate, with the averaged results presented in TABLE 3.

Using the values previously calculated and reported for each test organism at a given time interval for each test sample, the percent reduction versus the inoculum was calculated using the following equation:

[(A−B)/A]×100=Percent Reduction vs. Inoculum

where A=the average CFU of the test organism per 1 ml of inoculum added directly to the neutralizer solution without exposure to the sample, and B=the average value of the test organism recovered from each sample test piece.

The log (base 10) reduction was calculated for the ratio of the surviving organisms on the test sample versus the inoculum using the following equation:

log (C/B)=Log Reduction of Organisms on Test Sample vs. Untreated Control

where: C=the average cfu of the test organism recovered in the neutralizer-inoculum mixture after the specified contact time with the untreated control.

The AATCC Test Method 30(III) assay qualitatively evaluates the antifungal efficacy of products containing antimicrobial additives through the use of a single surrogate organism. This test utilizes Aspergillus niger, ATTC 6275, as a surrogate for a number of common fungi. The assay proceeds along these general lines:

1. Duplicate test pieces are made from the treated material and untreated control material, each piece approximately 1 to 1.5 inches on a side.

2. A fungal inoculum is prepared by adding scrapings from a ripe fruiting culture of Aspergillus niger to 50±1 ml of normal saline. Glass beads are placed therein and the flask shaken to liberate and suspend of the spores.

3. In a modification to the international standard test method, 1.0 ml sterile 0.05% aqueous solution of Triton X (a non-ionic surfactant) is added to each sample and blotted with an aseptic wiper prior to inoculation. Using a sterile glass pipette, 1.0±0.1 ml of the prepared inoculum is evenly distributed over the surface of each of four Petri dishes containing solidified Sabouraud Dextrose Agar.

4. A test piece or control piece is placed on the agar surface in the dish, over which is evenly distributed 0.2±0.0 ml. The sample then is covered and incubated at 28°±1° C. for 7 days.

5. After incubation, the surface of each test piece is visually examined to determine the percentage of surface area covered by the black fungus, Aspergillus niger. Growth is rated using the following rating system:
“0”—Sample exhibits strong antifungal activity
A sample earning this rating shall be totally free of fungal growth on the test surface and may exhibit a zone of inhibition against the test organisms applied to the nutritive agar on which the sample is placed. Observations of this type are common to materials treated with appropriate levels of antifungal agents.
“1”—Sample is not supportive of fungal growth
A sample earning this rating shall exhibit only irregular, unhealthy fungal infestation on the test surface as evidenced by discontinuous fungal mat and the appearance of stressed or weakened sporangiophores.
“2”—Sample is susceptible to fungal growth
A sample earning this rating shall exhibit regular, healthy fungal infestation on the test surface comparable to that on the nutritive agar surrounding the sample. The rating should include a percent estimate of the total surface so infested.

6. If a zone of inhibition is present on the plate, its width is calculated (using the following equation) and reported along with the rating score.

W=(T−D)/2

where W is the width of clear zone of inhibition (mm); T is the total diameter of test specimen and clear zone (mm); and D is the diameter of the test specimen (mm).

As is clear, three of the samples did not pass the bacterial tests: both black samples and the first green sample. None of the samples showed any signs of fungal growth after the 7-day TM30(III) test; however, the samples are visually analyzed and on the black samples, it is possible that there may have been microscopic growth that was missed by the microbiologist (perhaps due to the lack of contrast—the fungus is as black as the sample material).

The polyurethane foam itself generally is not a fungus-friendly substrate, although some of the previous controls have shown macroscopic fungal growth. This is presumed to be because the TM30(III) protocol adds some nutrients to the system to mimic the oils and skin cells that would collect over time on a shoe insole. The first sample further showed traces of arsenic in an EDX scan; the presence of arsenic may have inhibited the fungal growth to some degree on this sample.

TABLE 3

| Sample | JIS Z 2801 Kp | JIS Z 2801 Sa |
|---|---|---|
| #1 - Green | NR | NR |
| #2 - Black | NR | NR |
| #3 - Green | 99.9% | 99.9% |
| #4 - Black | NR | NR |
| #5 - Green | 99.9% | 99.9% |
| #6 - Green (thin) | 99.9% | 99.9% |
| #7 - Green | 99.9% | 99.9% |

TABLE 3a

| | | Log | |
|---|---|---|---|
| | Recovery | Reduction | Log Reduction |
| Sample Description | (CFU) | v. control | v. inoculum |
| Control 1 + Control Average | 1450 | -baseline- | -NA- |
| 0.4% Set 2 Additive Sample 1 | <100 | >1.16 | >3.22 |
| 0.4% Set 2 Additive Sample 2 | <100 | >1.16 | >3.22 |
| 0.4% Set 6 Additive Sample 1 | <100 | >1.16 | >3.22 |
| 0.4% Set 6 Additive Sample 2 | <100 | >1.16 | >3.22 |
| 0.4% Set 10 Additive Sample 1 | <100 | >1.16 | >3.22 |
| 0.4% Set 10 Additive Sample 2 | <100 | >1.16 | >3.22 |
| 0.8% Set 2 Additive Sample 1 | <100 | >1.16 | >3.22 |
| 0.8% Set 2 Additive Sample 2 | <100 | >1.16 | >3.22 |
| 0.8% Set 6 Additive Sample 1 | <100 | >1.16 | >3.22 |
| 0.8% Set 6 Additive Sample 2 | <100 | >1.16 | >3.22 |
| 0.8% Set 10 Additive Sample 1 | <100 | >1.16 | >3.22 |
| 0.8% Set 10 Additive Sample 2 | <100 | >1.16 | >3.22 |

Taking the analytical results into account, these data clearly demonstrate that samples have been treated with the antimicrobial composition disclosed herein are strongly efficacious against bacteria and fungi.

All materials treated with the zinc pyrithione composition disclosed herein passed all antibacterial and antifungal test procedures. The materials without the disclosed composition all failed the antibacterial tests. It is bacteria that generally cause the odor issues in shoe applications.

TABLE 4

| Sample | TM30(iii) A/B |
|---|---|
| #1 - Green | 0/0 |
| #2 - Black | 0/0 |
| #3 - Green | 0/0 |
| #4 - Black | 0/0 |
| #5 - Green | 0/0 |
| #6 - Green (thin) | 0/0 |
| #7 - Green | 0/0 |

TABLE 4a

| Sample Description | Rating | Comments |
|---|---|---|
| Control 1 + Control Average | 1 | Growth on side |
| 0.4% Set 2 Additive Sample 1 | 2 | Growth on side, |
| | | some on the top |
| 0.4% Set 2 Additive Sample 2 | 0 | Very clean, no growth |
| 0.4% Set 6 Additive Sample 1 | 0 | Very clean, no growth |
| 0.4% Set 6 Additive Sample 2 | 0 | Very clean, no growth |
| 0.4% Set 10 Additive Sample 1 | 0 | Very clean, no growth |
| 0.4% Set 10 Additive Sample 2 | 0 | Very clean, no growth |
| 0.8% Set 2 Additive Sample 1 | 0 | Very clean, no growth |
| 0.8% Set 2 Additive Sample 2 | 0 | Very clean, no growth |
| 0.8% Set 6 Additive Sample 1 | 0 | Very clean, no growth |
| 0.8% Set 6 Additive Sample 2 | 0 | Very clean, no growth |
| 0.8% Set 10 Additive Sample 1 | 0 | Very clean, no growth |
| 0.8% Set 10 Additive Sample 2 | 0 | Very clean, no growth |

Data further demonstrate that the antimicrobial composition and its manufacturing method do not perturb the antimicrobial properties of the antimicrobial active agent (in the above examples, zinc pyrithione) and that the composition is readily compatible with polymeric substrates such as, without limitation, polyurethane foam; flexible polyvinyl chloride; glues, binders and adhesives; rubbers; and latexes.

It will therefore be readily understood by those persons skilled in the art that the present composition and methods are susceptible of broad utility and application. Many embodiments and adaptations other than those herein described, as well as many variations, modifications and equivalent arrangements, will be apparent from or reasonably suggested to one of ordinary skill by the present disclosure and the foregoing description thereof, without departing from the substance or scope thereof.

Accordingly, while the present composition and methods have been described herein in detail in relation to its preferred embodiment, it is to be understood that this disclosure is only illustrative and exemplary and is made merely for purposes of providing a full and enabling disclosure.

The foregoing disclosure is not intended or to be construed to limit or otherwise to exclude any such other embodiments, adaptations, variations, modifications and equivalent arrangements.

What is claimed is:

1. A method for manufacturing an antimicrobial composition, comprising:
forming a pre-mixture by combining dipropylene glycol and a polyethylene glycol distearate;
warming the pre-mixture, optionally with agitation, to dissolve the polyethylene glycol distearate;
introducing a polyvalent metal salt of a pyrithione to the pre-mixture, with agitation sufficient to disperse the polyvalent metal salt of a pyrithione therein;
cooling the pre-mixture to form an antimicrobial composition;
wherein the antimicrobial composition possesses a viscosity at 25° C. in the range of 2000-3000 centipoise.

2. The method of claim 1 wherein the ratios of dipropylene glycol, polyethylene glycol distearate, and polyvalent metal salt of pyrithione in the pre-mixture are 740:10:250 by weight.

3. The method of claim 1 wherein the ratios of dipropylene glycol, polyethylene glycol distearate, and polyvalent metal salt of pyrithione in the pre-mixture are 620:5:375 by weight.

4. The method of claim 1 wherein the ratios of dipropylene glycol, polyethylene glycol distearate, and polyvalent metal salt of pyrithione in the pre-mixture are 860:15:125 by weight.

5. The method of claim 1 wherein the polyvalent metal salt of a pyrithione is bis(2-pyridylthio)zinc 1,1′-dioxide.

6. The method of claim 1 wherein the antimicrobial composition, after agitation, possesses a viscosity at 25° C. of less than 400 centipoise.

7. The method of claim 1 wherein the antimicrobial composition, after agitation, possesses a viscosity at 25° C. of less than 400 centipoise.

8. The method of claim 1 wherein the antimicrobial composition, after agitation, possesses a viscosity at 25° C. of less than 300 centipoise.

9. The method of claim 1 wherein the antimicrobial composition, after agitation, possesses a viscosity at 25° C. of less than 200 centipoise.

10. The method of claim 1 wherein the antimicrobial composition, after agitation, possesses a viscosity at 25° C. of less than 100 centipoise.

11. An antimicrobial composition produced by the method of claim 1.

12. An antimicrobial composition, comprising:
an antimicrobial agent dispersion consisting essentially of:
(i) dipropylene glycol;
(ii) polyethylene glycol distearate, and
(iii) a polyvalent metal salt of a pyrithione,
(iv) wherein amounts of dipropylene glycol, polyethylene glycol distearate, and polyvalent metal salt of a pyrithione are in a ratio of 740:10:250 by weight; and
wherein the antimicrobial composition has a viscosity in the range of 2000-3000 centipoise at 25° C.

13. The antimicrobial composition of claim 12:
wherein the antimicrobial composition before agitation has a viscosity in the range of 2000-3000 centipoise at 25° C.; and
wherein the viscosity of the composition after agitation is less than 400 centipoise at 25° C.

14. The antimicrobial composition of claim 12:
wherein the antimicrobial composition before agitation has a viscosity in the range of 2000-3000 centipoise at 25° C.; and
wherein the viscosity of the composition after agitation is less than 300 centipoise at 25° C.

15. The antimicrobial composition of claim 12:
wherein the antimicrobial composition before agitation has a viscosity in the range of 2000-3000 centipoise at 25° C.; and
wherein the viscosity of the composition after agitation is less than 200 centipoise at 25° C.

16. The antimicrobial composition of claim 12:
wherein the antimicrobial composition before agitation has a viscosity in the range of 2000-3000 centipoise at 25° C.; and
wherein the viscosity of the composition after agitation is less than 100 centipoise at 25° C.
